(19) United States
(12) Patent Application Publication
(10) Pub. No.: US 2023/0402033 A1
(43) Pub. Date: Dec. 14, 2023

(54) Device Language Configuration Based on Audio Data

(71) Applicant: Comcast Cable Communications, LLC, Philadelphia, PA (US)

(72) Inventors: Julianne Heinzmann, Philadelphia, PA (US); Arpit Mathur, Pittsburgh, PA (US); Scott A. Armstrong, Wayne, PA (US); Arun Ravisankar, Philadelphia, PA (US); Resmi Vijayan, Philadelphia, PA (US); Natalie Mazer, Philadelphia, PA (US)

(21) Appl. No.: 17/835,362

(22) Filed: Jun. 8, 2022

(51) Int. Cl. G10L 15/22; G06F 3/16; G10L 15/00; G10L 15/06

(52) U.S. Cl. CPC G10L 15/22; G06F 3/167; G10L 15/005; G10L 15/063; G10L 2015/223

(57) ABSTRACT

Systems, apparatuses, and methods are described for modifying language and/or recording settings of a computing device based on audio data. Audio data comprising speech may be received by a computing device. The computing device may process the audio data to determine one or more properties of speech of one or more users. Based on the one or more properties of the speech, language settings and/or recording settings may be modified. For example, subtitles may be displayed or removed, accessibility features may be implemented, different content may be displayed, and/or machine translation functions may be activated. Such language and/or recording settings may be stored in a user profile, which may be used by a variety of computing devices.

### BACKGROUND

Computing devices may provide content (e.g., user interfaces, audio content, textual content, video content) in a variety of different languages based on language settings for those computing devices. For example, a user might modify the language of their operating system using a configuration menu, and/or might watch foreign language video content with subtitles enabled. As a wider variety of users consume an increasingly varied quantity of content, it is increasingly likely that computing device language settings are misconfigured. For example, a computing device might inadvertently display subtitles in a language that cannot be read by a viewer, and/or might output audio data too quickly to be consumed by a hearing-impaired listener.

### SUMMARY

The following summary presents a simplified summary of certain features. The summary is not an extensive overview and is not intended to identify key or critical elements.

Systems, apparatuses, and methods are described for modifying the language preferences of computing devices based on audio data. A computing device may receive audio content corresponding to the speech of one or more different users. Based on processing that audio content, the computing device may determine language settings for the display of content. For example, based on detecting that a viewer speaks Spanish, English, and combinations thereof, the computing device may disable subtitles when displaying Spanish-language content, but may enable subtitles when displaying Japanese-language content. As another example, based on detecting that a viewer speaks in Spanish and determining that the viewer speaks a command (and, e.g., not the title of content), the computing device may change language settings to Spanish. The computing device may store a user profile indicating such language preferences. Moreover, based on the processing of that audio content, accessibility features may be implemented. For example, the speed of audio content may be modified based on detecting that a user speaks with a slow cadence.

These and other features and advantages are described in greater detail below.

### BRIEF DESCRIPTION OF THE DRAWINGS

Some features are shown by way of example, and not by limitation, in the accompanying drawings In the drawings, like numerals reference similar elements.

FIG. 1 shows an example communication network.

FIG. 2 shows hardware elements of a computing device.

FIG. 3 is a flow chart showing an example method for modifying language settings based on the processing of audio data.

FIG. 4 is a flow chart showing an example method for modifying language settings as part of step 305 of FIG. 3.

FIG. 5 is a flow chart showing an example method for processing audio data using a machine learning model, as well as subsequent machine learning model training steps.

FIG. 6 is a flow chart showing an example method for creating and modifying a user profile.

FIG. 7A shows an example display with a television remote and a user providing a voice command.

FIG. 7B shows the example display of 7A after language settings have changed based on the voice command of FIG. 7A.

FIG. 8 shows examples of user profiles.

FIG. 9 shows a deep neural network.

FIG. 10 is a flow chart showing an example method for modifying language settings based on the processing of audio data and based on whether words correspond to a command.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

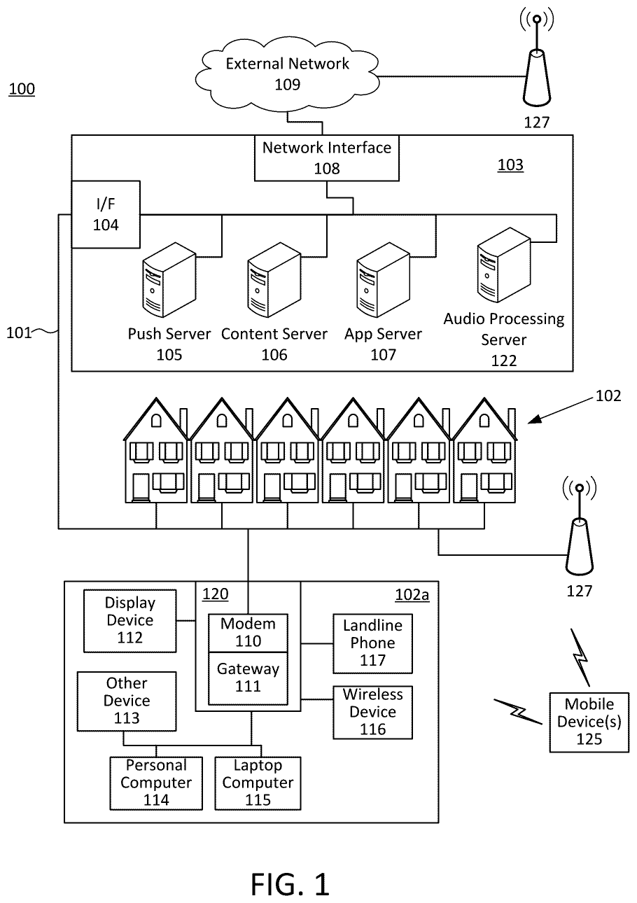

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the audio processing server 122 (described below), additional push, content, and/or application servers, and/or other types of servers. Although shown separately, the push server 105, the content server 106, the application server 107, the audio processing server 122, and/or other server(s) may be combined and/or server operations described herein may be distributed among servers or other devices in ways other than as indicated by examples included herein. Also or alternatively, one or more servers (not shown) may be part of the external network 109 and may be configured to communicate (e.g., via the local office 103) with other computing devices (e.g., computing devices located in or otherwise associated with one or more premises 102). Any of the servers 105-107, and/or 122, and/or other computing devices may also or alternatively be implemented as one or more of the servers that are part of and/or accessible via the external network 109. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

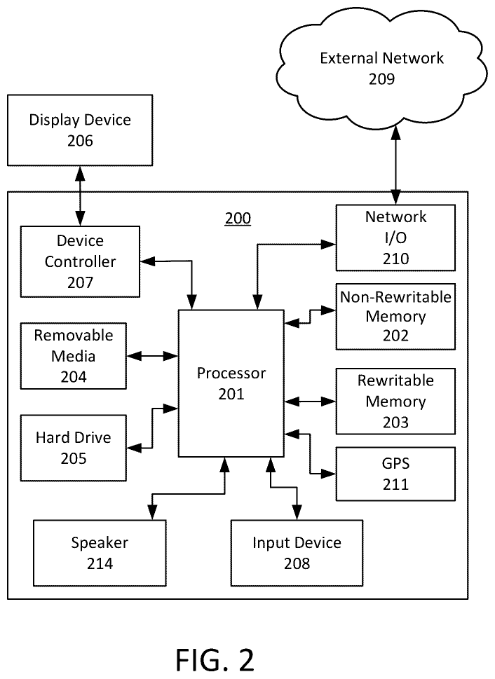

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices associated with the external network 109) and any other computing devices discussed herein (e.g., set-top boxes, personal computers, smartphones, remote controls, and the like). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

As described herein, language settings and/or recording settings of a computing device (e.g., any of the devices described above with respect to FIG. 1 and/or FIG. 2) may be modified based on audio data. As also described herein, example methods to perform such modification may comprise processing speech of a user (e.g., as captured in audio data recorded by the same or different computing devices), determining properties of that speech (e.g., the language(s) spoken by a user, the cadence of the user, any potential communication difficulties experienced by the user), and appropriately modifying computing device settings based on determined properties.

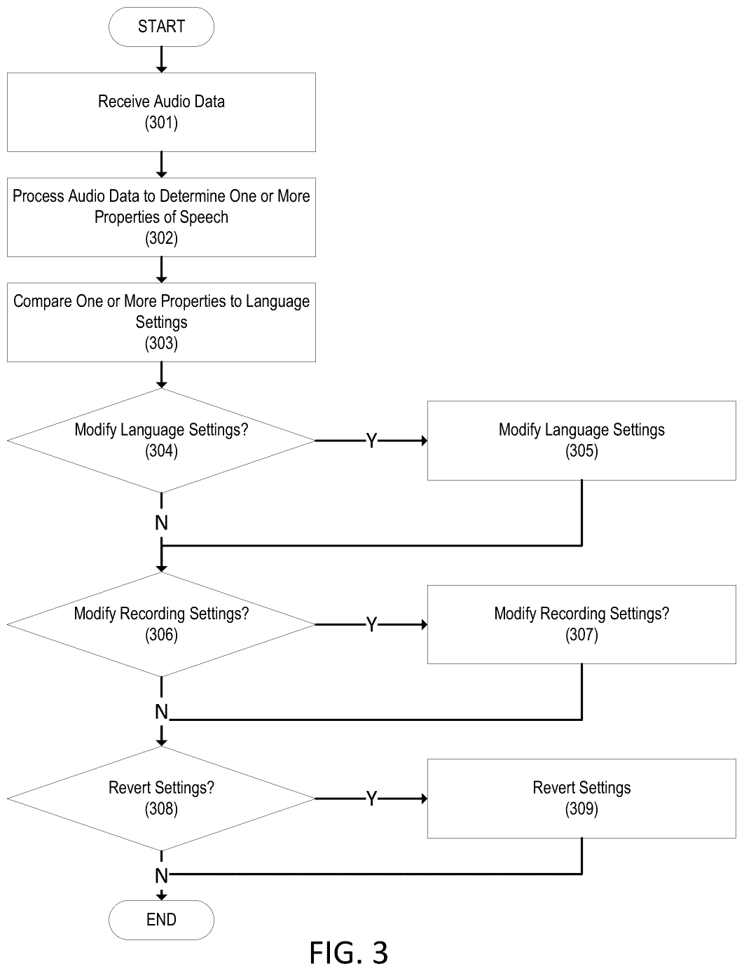

FIG. 3 is a flow chart showing an example method for modifying language settings based on the processing of audio data. Steps depicted in the flow chart shown in FIG. 3 may be performed by a computing device, such as a computing device with one or more processors and memory storing instructions that, when executed by the one or more processors, cause performance of one or more of the steps of FIG. 3. Such computing device may comprise, for example, one or more gateways (e.g., the gateway 111), television set-top boxes, personal computers, laptops, desktop computers, servers, smartphones, or the like, including any of the computing devices discussed with respect to FIG. 1 and/or FIG. 2. The steps depicted in the flow chart shown in FIG. 3 may additionally and/or alternatively be performed by one or more devices of a system, and/or as performed when stored on computer-readable media. The steps shown in FIG. 3 may be reconfigured, rearranged, and/or revised, and/or one or more other steps added.

In step 301, the computing device may receive audio data. Receiving audio data may comprise receiving data that indicates all or portions of vocalizations made by a user. For example, the computing device may receive audio data corresponding to speech of a user. The audio data may be received from one or more sources, such as via a microphone of the computing device, a microphone of a different computing device, or the like. For example, the audio data may be received, via a network, from a smartphone, voice-enabled remote control, and/or similar computing devices. The audio data may be in a variety of formats. For example, the audio data may comprise a recording (e.g., an .mp3 file) of a user's speech. As another example, the audio data may comprise speech-to-text output of an algorithm that has processed the speech of a user.

A microphone or similar audio capture device may record multiple different users, such that the audio data may comprise the speech of one or more different users. For example, the audio data may correspond to speech of a plurality of different users. In turn, the audio data may comprise a variety of different spoken languages, speech cadences, and the like. For example, a multilingual family may speak in both English and Chinese, or a combination thereof. As another example, within a multigenerational family, older family members might have difficulty hearing and speak with a slower but louder cadence, whereas younger family members might speak more quickly but more quietly.

In step 302, the computing device may process the received audio data to determine one or more properties of speech by one or more users. For example, the computing device may process the audio data to determine one or more properties of the speech of the user. The one or more properties of the speech may comprise any subjective or objective characterization of the speech, including but not limited to a language of the speech, a cadence of the speech, a volume of the speech, one or more indicia of communication limitations indicated by the speech, or the like.

The one or more properties of speech may indicate a language spoken by a user. To determine a language spoken by the user, the computing device may process the audio data using one or more algorithms that compare sounds made by the user to sounds associated with various languages. Additionally and/or alternatively, to determine a language spoken by the user, the computing device may use a speech-to-text algorithm to determine one or more words spoken by a user, then compare the one or more words to words associated with different languages. The language spoken by the user may correspond to both languages (e.g., English, Spanish, Japanese) as well as subsets of those languages (e.g., specific regional dialects of English). For example, the computing device may process the audio data to determine a particular regional dialect of English spoken by a user. As will be described below, this language information may be used to modify user interface elements (e.g., to switch user interface elements to a language spoken by one or more users), to select content (e.g., to play an audio track corresponding to a language spoken by the one or more users), or the like.

The one or more properties of speech may indicate a speech pattern of a user. The particular loudness, cadence, and overall tenor of the speech of a user may suggest information about a user's relationship to a language. For example, mispronunciations, slow speech, and mistakes in use of certain terms may suggest that a user has a limited understanding of a particular language. In such a circumstance, and as will be described below, it may be desirable to provide simplified forms of this language for the user. As one example, the one or more properties of speech may suggest that a user has only a basic understanding of Japanese, such that user interface elements should be displayed in hiragana or katakana instead of kanji. In this manner, the one or more properties of speech may indicate stuttering, speech impediment(s), atypical speech patterns (e.g., hearing loss), slurred speech, or the like.

The one or more properties of speech may indicate communicative limitations of a user. In some circumstances, the manner in which a user speaks may suggest that they have difficulty communicating. For example, certain speech patterns may suggest that a user may be wholly or partially deaf. In such a circumstance, and as will be described below, it may be desirable to modify presentation of content (by, e.g., turning on subtitles/captions, increasing the volume of content, or the like).

Processing the audio data may comprise determining a language spoken by two or more of a plurality of different users. The audio data may correspond to speech by a plurality of different users. For example, multiple users may speak in a living room, and the audio data may comprise portions of both users' speech. In such a circumstance, the computing device may be configured to determine one or more portions of the audio data that correspond to each of a plurality of different users, then determine one or more properties of the speech of each user of the plurality of different users. This processing may be used to determine language and/or recording settings for multiple users. For example, a majority of users captured in audio data speak Spanish, but one of the plurality may speak Portuguese. In such a circumstance, the computing device may determine (e.g., based on a count of the one or more users speaking Spanish versus those speaking Portuguese) whether to modify the language settings to Spanish or Portuguese.

Processing the audio data may comprise determining whether one or more words correspond to a command. A user's speech might comprise a command (e.g., “Play,” “Pause”) and/or the title of content (e.g., the name of a movie), such that the audio data might comprise a combination of both a command and a title of content (e.g., “Play [MOVIE NAME],” “Search for [SHOW NAME]”). The computing device may determine which words, of one or more words spoken by a user, correspond to a command. The computing device may additionally and/or alternatively determine which words, of the one or more words spoken by the user, correspond to a title of content, such as the title of a movie, the title of television content, or the like. The computing device may be configured to modify language settings based on the language used by a user for commands, but not the language used by a user for content titles. For example, the computing device may change language settings to English based on determining that a user used the English word “Play” as a command, but the computing device might not change language settings when a user uses the Spanish title of a movie. To determine whether one or more words correspond to a command, the computing device may process the audio data to identify one or more words, then compare those words to a database of words that comprises commands in a variety of languages. In this manner, the computing device may determine not only that a word is a command (e.g., “Play”), but that the command is in a particular language (e.g., English).

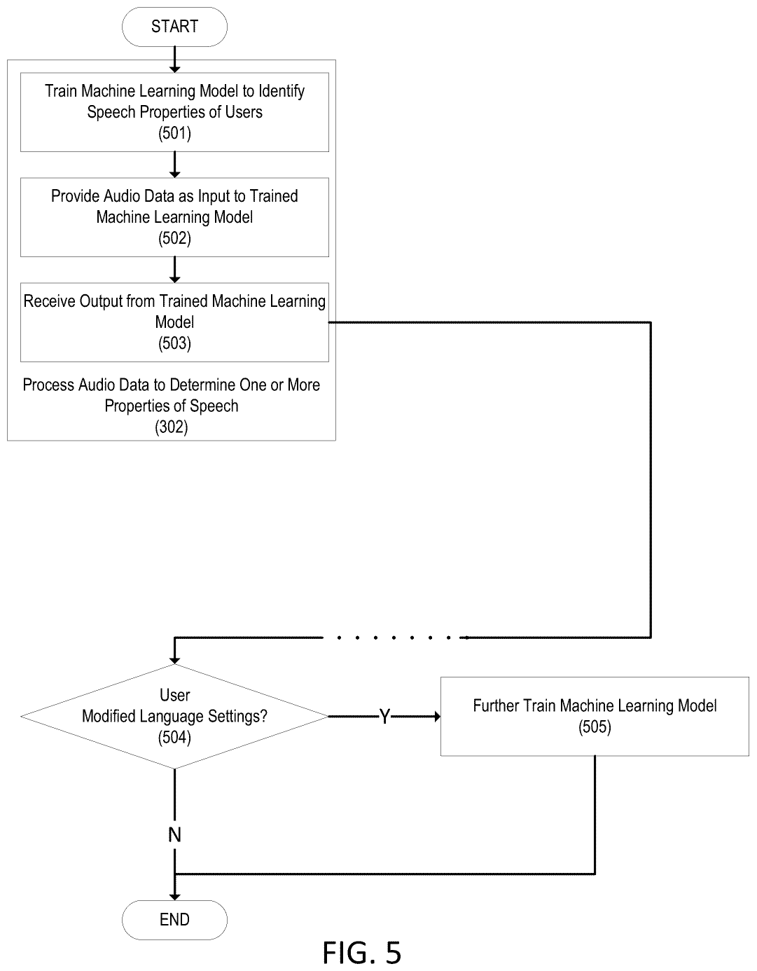

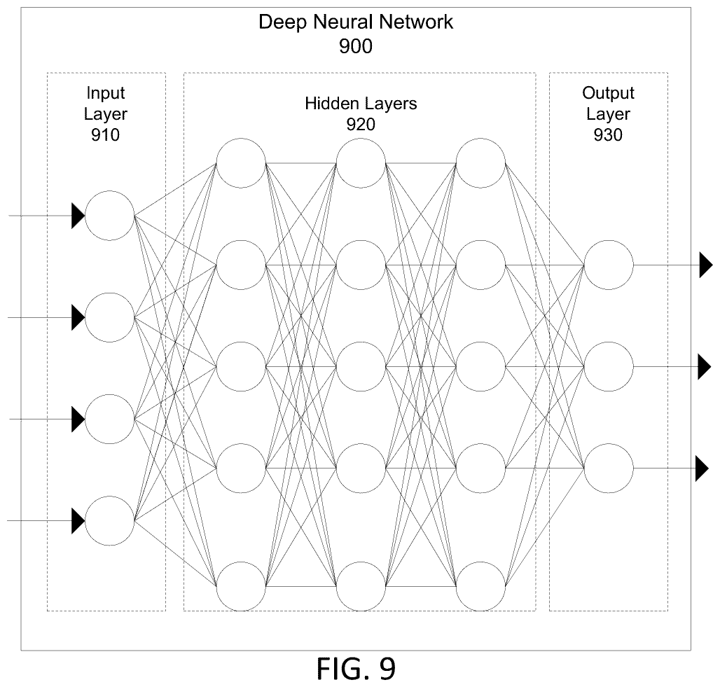

As art part of processing the audio data to determine one or more properties of speech indicated in audio data in step 302, the computing device may train a machine learning model to identify the speech properties of users. To perform this training, training data may be used with respect to the machine learning model. That training data may comprise, for example, associations between audio content corresponding to speech of a plurality of different users and properties of the speech of the plurality of different users. In this manner, the trained machine learning model may be configured to receive input (e.g., audio data) and provide output (e.g., indication(s) of the one or more properties of the speech indicated by the audio data). An example of a neural network which may be used to implement such a machine learning model is provided below with respect to FIG. 9. Moreover, additional discussion of the use of trained machine learning models in this manner is provided below with respect to FIG. 5.

In step 303, the computing device may compare the one or more properties determined in step 302 to language settings. This comparison may determine whether there is a difference between the current language settings of a computing device versus the one or more properties of the speech of the user. For example, the computing device may compare the one or more properties of command-related words included in the speech of the user to language settings of the computing device to determine, e.g., if the user interface is displaying text in a language that is the same as that spoken by the users captured in the audio data. In this manner, step 303 may comprise determining whether the language settings of one or more computing devices are consistent with the one or more properties of speech determined as part of step 302.

In step 304, the computing device may determine, based on the comparing in step 303, whether to modify the language settings. Language settings may comprise any settings which govern the manner of presentation of content, such as the language with which video, audio, or text is displayed, the speed at which video, audio, or text is displayed, or the like. As indicated above, step 303 may comprise determining whether the language settings of one or more computing devices are inconsistent with the one or more properties of speech determined as part of step 302. If such an inconsistency exists (e.g., if the language settings are inconsistent with the one or more properties of speech), the computing device may determine to modify the language settings (e.g., to switch a display language of a user interface element, to turn on subtitles/captions, or the like). If the computing device determines to modify the language settings, the computing device may perform step 305. Otherwise, the computing device may perform step 306.

Determining whether to modify the language settings may comprise determining whether one or more portions of the speech correspond to a command. Speech may comprise indications of commands, but might additionally and/or alternatively comprise indications of the titles of content. Moreover, a user might speak one language, but refer to the title of content (e.g., a movie, a television show, a song, a podcast) in another language. In turn, the language a user uses for commands might be different than the language used by the same user for the title of content. For example, a user might speak English to issue a command (e.g., “Play,” “Pause”), but may speak the Spanish name of a Spanish television show. In such an example, it may be preferable to maintain the language settings in English and not switch the settings to Spanish. In contrast, if that same user provided commands (e.g., “Play”) in Spanish, whether or not the user used the Spanish or English language title of a content item, the user's use of Spanish may indicate that the language settings should be switched to Spanish. Accordingly, if a user provides a command in a language, the computing device may determine to modify the language settings based on that language. In contrast, if the user recites the name of content, the language settings might not be changed.

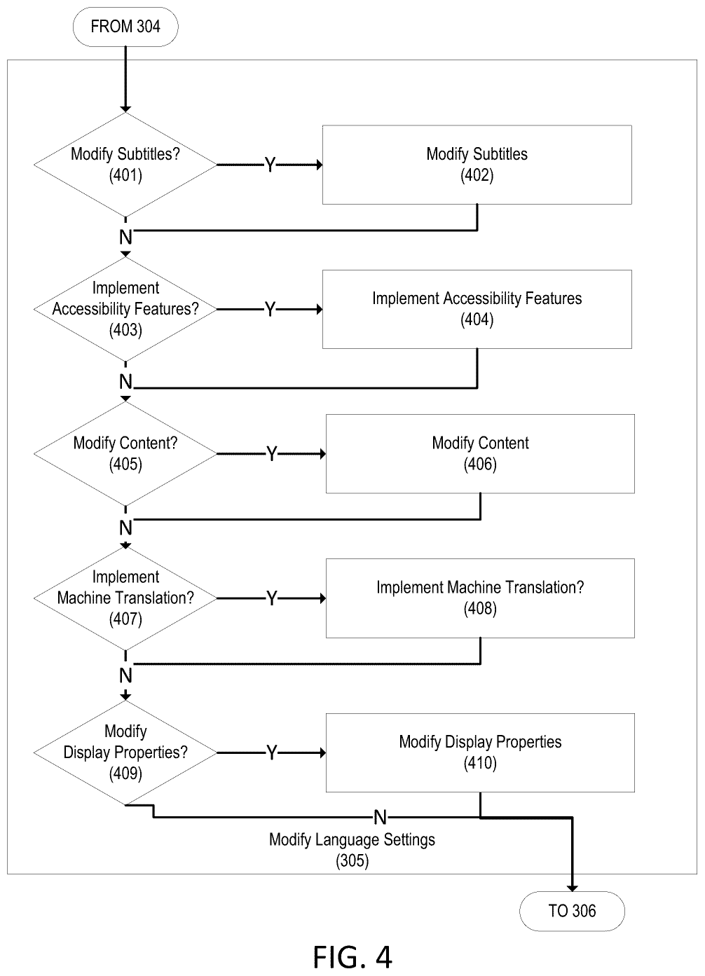

In step 305, the computing device may modify the language settings. For example, the computing device may modify, based on the comparing in step 303, whether or not the speech corresponds to a command, and/or the one or more properties determined in step 302, the language settings of the computing device to, e.g., turn subtitles/captions on or off, change subtitle language, switch an audio track of content to a particular language, implement accessibility features, implement machine translation, or the like. As part of this process, the computing device may determine a language indicated by the one or more properties. For example, the computing device may determine a language indicated by the one or more properties, then modify the language settings of the computing device based on that language. As part of step 305, the computing device may determine (e.g., based on the one or more properties determined in step 302) a language used to display video content, audio content, and/or textual content. For example, the computing device may modify a language setting (e.g., for subtitles/captions, for user interface element(s), for an audio track) to match a language spoken by one or more users. More examples of how the language settings of the computing device may be modified are described below in connection with FIG. 4.

Modifying the language settings may comprise prompting a user to modify the language settings. For example, the computing device may cause display of a user interface element providing an option, to a user, to modify the language settings. Additionally and/or alternatively, in certain circumstances, modification of language settings may be performed automatically. For example, a computing device displaying content on a television in a public area (e.g., an office lobby) might be configured to automatically modify language settings based on audio captured by speech of those in the office lobby. As another example, if the one or more properties determined in step 303 indicate a single language (and/or a predominant language), the indicated language may be automatically selected and language settings automatically modified based on that automatic selection.

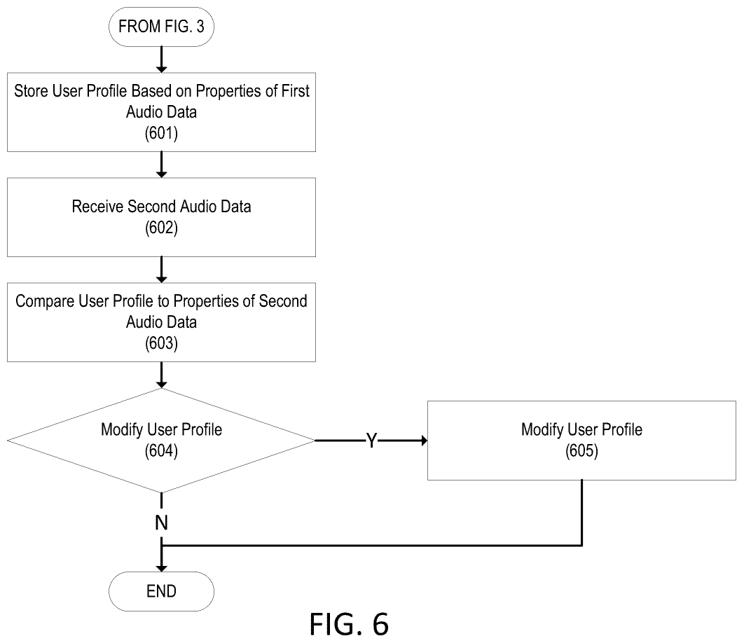

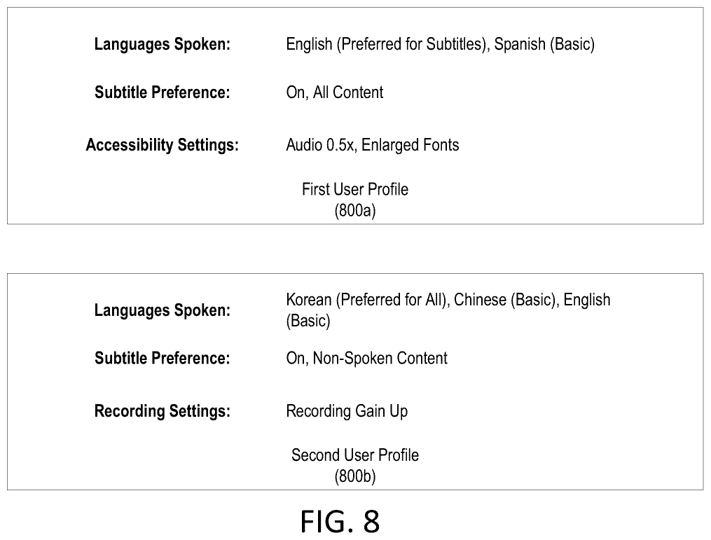

As part of modifying the language settings, the computing device may create and/or store a user profile. A user profile may comprise a data element which may store all or portions of language settings and/or recording settings for one or more users. That user profile may be used by the computing device and/or one or more other computing devices to implement language settings and/or recording settings. For example, the computing device may store a user profile that indicates the one or more properties of the speech of the user, and then provide, to one or more second computing devices, the user profile. In this manner, one computing device may determine (for example) that a user speaks Spanish, create a user profile that indicates that the user speaks Spanish, and that user profile may be used by a wide variety of devices to configure their user interfaces to display Spanish text. Further description of user profiles is provided below with respect to FIG. 6 and FIG. 8.

In step 306, the computing device may determine, based on the comparing in step 303 and/or based on whether the speech corresponds to a command, whether to modify recording settings. Recording settings may comprise settings that control the manner of capture of audio data, such as the audio data received in step 301. The one or more properties determined in step 303 may indicate, for example, that modifications to recording settings should be made to better capture speech of a user. For example, if a user speaks quietly but slowly, the computing device may increase its gain and record for a longer duration so as to better capture the voice of a user. This may be particularly useful where one or more computing devices implement voice commands, as modification of the recording settings may enable the computing device to better capture voice commands spoken by a user. If the computing device determines to modify the recording settings, the computing device may perform step 307. Otherwise, the computing device may perform step 308.

In step 307, the computing device may modify recording settings. For example, the computing device may modify, based on the one or more properties of the speech of the user determined in step 302, recording settings of the user device. Modifying the recording settings may comprise, for example, modifying a gain of a microphone of one or more computing devices, modifying a duration with which audio content is recorded by one or more computing devices, modifying one or more encoding parameters of an encoding of audio data captured by a computing device, modifying pitch/tone control of a microphone used to capture audio data, implementing voice normalization algorithms, or the like.

In step 308, the computing device may determine whether to revert the language settings and/or the recording settings. It may be desirable to reset a computing device back to default language and/or recording settings after a period of time has expired. Accordingly if the computing device determines to revert the language settings and/or the recording settings (e.g., because an elapsed time has satisfied a threshold associated with reverting the settings), the computing device may perform step 309. Otherwise, the method may proceed to the steps depicted in FIG. 6. Additionally and/or alternatively, the method depicted in FIG. 3 may be repeated (e.g., in response to receipt of additional audio data)

In step 309, the computing device may revert the language and/or recording settings. Reverting the language and/or settings may comprise modifying the language and/or recording settings to a state before step 305 and/or step 307 were performed. After step 309, the steps depicted in FIG. 6 may be performed.

FIG. 4 is a flow chart showing an example, as part of the method of FIG. 3, steps for modifying language settings as part of step 305 of FIG. 3. One or more of the steps of FIG. 4 may be modified, rearranged, omitted, or replaced, and/or other steps added.

In step 401, the computing device may determine whether to modify subtitles. Subtitles may comprise captions and/or any other text for display that corresponds to audio and/or video content. If a user speaks a different language than an audio track, and/or if a user has hearing difficulties, it may be desirable to turn on subtitles for that user. Similarly, if a user speaks a particular language, it may be desirable to switch the subtitle language to a language spoken by a user. If the computing device decides to modify the subtitles, the computing device may perform step 402. Otherwise, the computing device may perform step 403.

In step 402, the computing device may modify subtitles. For example, the computing device may modify subtitle settings of the computing device to turn subtitles on or off, change a language of subtitles, or the like. To modify the subtitles, the computing device may transmit instructions to a video player application to enable subtitles, disable subtitles, modify a language of subtitles, or the like. Multiple subtitles may be shown. For example, based on determining that one user speaks Spanish but another user speaks English, both English and Spanish subtitles may be shown simultaneously.

In step 403, the computing device may determine whether to implement accessibility features. Accessibility features may comprise, for example, slowing down audio and/or video, modifying a size of displayed text, implementing colorblindness modes, or any other settings that may be used to make content more easily consumed by users (such as visually, aurally, and/or physically impaired users). If the computing device decides to implement accessibility features, the computing device may perform step 404. Otherwise, the computing device may perform step 405.

In step 404, the computing device may implement accessibility features. For example, the computing device may modify a playback speed of content, may modify a size of displayed text, may simplify words and/or controls displayed by an application, or the like.

In step 405, the computing device may determine whether to modify content. Modifying content may comprise selecting content for display, changing content currently displayed by a computing device, ending the display of content, or the like. If the computing device decides to modify content, the computing device may perform step 406. Otherwise, the computing device may perform step 407.

In step 406, the computing device may modify content. Modifying the content may comprise selecting content for display. For example, the computing device may select, based on the one or more properties of the speech of the user determined in step 302, content, and then cause display of that selected content. In this way, a computing device might select a version of a movie in a language that is spoken by a user. This selection process may be used for other purposes as well: for example, the computing device might select a Spanish television show for display based on determining that a user speaks Spanish, and/or might select a particular notification and/or advertisement based on the language spoken by a user.

One example of how content may be modified is in the selection of content for display. A user may speak, using a voice remote, a command requesting that a movie be played. That command may be in a particular language, such as Chinese. Based on detecting that the command is in Chinese, the computing device may determine a version of the movie in Chinese, then cause display of that movie. This process might be particularly efficient where the same movie might have different titles in different languages, as identifying the language spoken by the user might better enable the computing device to retrieve the requested movie.

In step 407, the computing device may determine whether to implement machine transaction. In some circumstances, content in a particular language might not be available. For example, a movie might have English and Spanish subtitles, but not Korean or Japanese subtitles. Similarly, a user interface might be configured to be displayed in English and Spanish, but not Korean or Japanese. In such circumstances, the computing device may use a machine translation algorithm to, where possible, translate content to a language spoken by a user. For example, the computing device may use a machine translation algorithm to translate English subtitles into Korean subtitles. If the computing device decides to implement machine translation, the computing device may perform step 408. Otherwise, the computing device may perform step 409.

In step 408, the computing device may implement machine translation. For example, the computing device may perform machine translation of text content (e.g., subtitles, user interface elements, or the like).

In step 409, the computing device may determine whether to modify display properties. Display properties may comprise any aspect of the manner with which content is displayed, including a size of user interface elements, a resolution of content displayed on a display screen, or the like. If the computing device decides to modify display properties, the flow chart may proceed to step 410. Otherwise, the flow chart may proceed to step 306 of FIG. 3.

In step 410, the computing device may modify display properties. For example, the computing device may modify display properties of a user interface provided by the computing device by, e.g., lowering a display resolution of content displayed by the computing device (e.g., to increase an overall size of user interface elements displayed on a display device), increasing the size of user interface elements displayed by the computing device, or the like.

The process described with respect to FIG. 3 and FIG. 4 may be performed with use of one or more machine learning models, such as might be implemented via a neural network. Such an implementation may, for example, and as described in connection with FIG. 5, use and/or otherwise be based on a machine learning model.

FIG. 5 is a flow chart showing an example method for processing audio data as part of step 302 using a machine learning model, as well as subsequent machine learning model training steps which might be performed thereafter. One or more of the steps of FIG. 5 may be modified, rearranged, omitted, or replaced, and/or other steps added.

In step 501, a machine learning model may be trained to identify speech properties of users. For example, the computing device may train a machine learning model to output, in response to input comprising audio data, indications of one or more properties of the speech contained in that audio data. The machine learning model may be trained by training data. The training data may be tagged, such that it comprises information about audio data that has been tagged to indicate which aspects of that audio data correspond to properties of speech. In this manner, the computing device may train, using training data, a machine learning model to identify speech properties of users.

The training data may indicate associations between speech and properties of that speech. In this manner, the training data may be tagged data which has been tagged by, e.g., an administrator. For example, the computing device may comprise associations between audio content corresponding to speech of a plurality of different users and properties of the speech of the plurality of different users. The audio content corresponding to speech of the plurality of different users may correspond to commands spoken by the plurality of different users. The properties of the speech of the plurality of different users may indicate a language of the commands spoken by the plurality of different users.

In step 502, the computing device may provide the audio data (e.g., from step 302) as input to the trained machine learning model. The audio data may be preprocessed before being provided to the trained machine learning model. For example, the audio data may be processed using a speech-to-text algorithm, such that the input to the trained machine learning model may comprise text data. As another example, various processing steps (e.g., noise reduction algorithms) may be performed on the audio data to aid in the clarity of the audio data.

In step 503, the computing device may receive output from the trained machine learning model. The output may comprise one or more indications of one or more properties of speech in the audio data provided as input in step 502. For example, the computing device may receive, as output from the trained machine learning model, an indication of one or more properties of the speech of the first user. The one or more properties indicated as part of this output may be the same or similar as discussed with respect to step 302 of FIG. 3.

Steps 504 and 505 describe a process which may occur any time after step 302 whereby the trained machine learning model may be further trained based on later information about a user. The trained machine learning model may output incorrect and/or inaccurate information. For example, the trained machine learning model might incorrectly identify the language spoken by a particular user. In such a circumstance, subsequent activity by a user (e.g., the user changing a language setting back) may indicate that the trained machine learning model provided incorrect output. This information (e.g., that the output was incorrect) may be used to further train the trained machine learning model, helping avoid such inaccuracy in the future. As such, the process described in steps 504 and 505 may be used to, after the training performed in step 501, improve the accuracy of the trained machine learning model.

In step 504, the computing device may determine whether a user modified the language settings. For example, the computing device may, after modifying the language settings of the computing device, receive an indication that the first user further modified the language settings of the computing device. Such a modification may indicate, as discussed above, that the trained machine learning model provided incorrect output. If the computing device determines that a user modified the language settings, the computing device may perform step 505. Otherwise, the method may proceed back to one or more of the steps of FIG. 3 (and/or may end). Additionally and/or alternatively, the method may be repeated (e.g., based on the receipt of additional audio data).

In step 505, the computing device may, based on determining that a user modified the language settings, further train the trained machine learning model. This training may be configured to indicate that the output from the trained machine learning model received in step 503 was incorrect in whole or in part. For example, the computing device may cause the trained machine learning model to be further trained based on the indication that the first user further modified the language settings of the computing device. In this manner, the trained machine learning model may procedurally learn, based on subsequent user activity, to better identify one or more properties of the speech of a user. After step 505, the method may proceed back to the one or more steps of FIG. 3 and/or may end.

User profiles, such as those discussed with respect to step 305 of FIG. 3, may be generated, stored, and/or updated. For example, and as described below in connection with FIG. 6, a user profile may be generated and updated based on different audio data received at, e.g., different times.

FIG. 6 is a flow chart showing an example method for creating and modifying a user profile, with steps which may be performed after the steps described with respect to FIG. 3. As such, like FIG. 3, steps of the flow chart shown in FIG. 6 may be performed by a computing device, such as a computing device with one or more processors and memory storing instructions that, when executed by the one or more processors, cause performance of one or more of the steps of FIG. 6. Such computing device may comprise, for example, television set-top boxes, personal computers, laptops, desktops, smartphones, or the like, including any of the computing devices discussed with respect to FIG. 1, FIG. 2, FIG. 3, FIG. 4, and/or FIG. 5. The steps of the flow chart shown in FIG. 6 may additionally and/or alternatively be performed by one or more devices of a system, and/or as performed when stored on computer-readable media. The steps shown in FIG. 6 may be reconfigured, rearranged, and/or revised, and/or one or more other steps added.

In step 601, the computing device may store a user profile for one or more first users based on one or more properties of the audio data received in step 301. The creation of the user profile may comprise processing the audio data to determine one or more properties of the audio data, such as is described with respect to step 302 of FIG. 3. Those one or more properties may be stored, in whole or in part, in a user profile. Additionally and/or alternatively, language settings based on those one or more properties may be stored, in whole or in part, in a user profile. For example, the computing device may store, based on one or more first properties of the speech of the first user, a user profile indicating language settings for the computing device. An example of such a user profile is described in detail in connection with FIG. 8.

The user profile may be configured to indicate one or more languages. In this manner, the user profile may indicate one or more languages associated with a user, such as one or more languages spoken by the user. The user profile may indicate a proficiency of the user with respect to the one or more languages, and/or may indicate a preference as to which language(s) should be used when displaying content for a user. For example, the user profile may be configured to cause display of video content in a first language, and may be configured to cause display of subtitles corresponding to a second language.

In step 602, the computing device may receive second audio data. That second audio data might not necessarily correspond to speech by one or more first users, as may have been the case with respect to the audio data received in step 301 and referenced in step 601. For example, speech corresponding to the second audio data may be from an entirely different user. This step may be the same or similar as step 301 of FIG. 3.

The computing device may receive the second audio data from a different device as compared to the device from which the first audio data was received (e.g., in step 301). As indicated with respect to step 301 of FIG. 3, audio data may be received via a variety of different computing devices. In turn, the second audio data need not be received from the same device as the first audio data. For example, receiving the first audio data may comprise receiving the first audio data via a first user device associated with the first user (e.g., the first user's smartphone), and receiving the second audio data may comprise receiving the second audio data via a second user device associated with a second user (e.g., a remote control input device with voice recording functionality).

In step 603, the computing device may compare the user profile stored in step 602 to one or more properties of the second audio data. For example, the computing device may compare the language settings with one or more second properties of the second audio data. This step may be the same or similar as step 303 of FIG. 3 in that the computing device may compare the one or more properties of the second audio data to the user profile (which may indicate current language settings for a particular user).

As part of comparing the user profile to the properties of the second audio data, the computing device may determine whether the second audio data is associated with the same user that is associated with the first audio data. For example, the computing device may determine whether the second audio data is associated with the first user. If the second audio data is received from the same user as the first audio data, then this may indicate that the user profile should be modified based on the second audio data. In this manner, for example, if a user begins speaking Spanish, then the computing device may modify that user's user profile to add Spanish to a list of languages, such that Spanish-language content is selected and provided to the user. If the second audio data is not received from the same user as the first audio data, then this may indicate that a new user profile (e.g., for a second user associated with the second audio data) should be created and stored.

In step 604, the computing device may determine whether to modify the user profile stored in step 601. This decision may be based on the comparing described in step 603 and/or based on determining whether the second audio data corresponds to a command. If the computing device determines to modify the user profile, the computing device may perform step 605. Otherwise, the method may end. Additionally and/or alternatively, the method may be repeated (e.g., based on the receipt of additional audio data).

In step 605, the computing device may modify the user profile. For example, the computing device may modify, based on the comparing of step 603 and the one or more second properties of the second audio data, the user profile. In this manner, languages may be added, removed, and/or altered in the user profile. For example, the first audio data may indicate that a user has a basic understanding of English, but the second audio data may indicate that the same user has a strong understanding of English. In such a circumstance, the user profile for that user may be modified such that an “English (Basic)” designation for languages is replaced with an “English (Advanced)” designation.

Modifying the user profile may comprise adding, to the user profile, an indication of an accessibility feature to be implemented via the computing device. As described with respect to step 403 and step 404 of FIG. 4, language settings may comprise accessibility features. In turn, the user profile may comprise one or more indications of accessibility features to be enabled and/or disabled for a particular user. For example, a user profile may indicate that, for a particular user, audio should be slowed down, and enlarged fonts should be shown.

A second computing device may use the user profile and/or the modified user profile. In this manner, the user profile may be used by a plurality of different computing devices, rather than just the computing device that created the user profile. For example, a second computing device may display content based on the modified user profile. That second computing device might be, for example, in a call center. In this manner, information about a user's language settings for their computer might be used by a call center system to route the user to a customer representative that speaks their language.

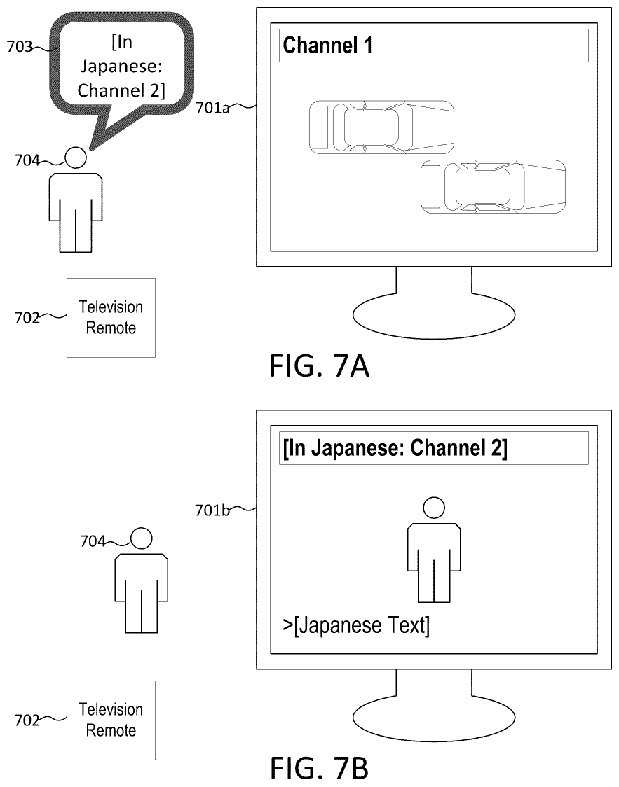

FIG. 7A shows an example of a display 701a, a television remote control input device 702, and a user 704, wherein the user is speaking a voice command 703. As indicated by the voice command 703, the user is speaking Japanese. This voice command 703 may be captured by a microphone of the television remote 702, which may be provided (e.g., wirelessly) to a different computing device. That process may be how the computing device receives audio data as part of step 301 of FIG. 3. The display 701a is showing an English language user interface element and does not show subtitles.

FIG. 7B shows the display of 7A after language settings have changed based on the voice command of FIG. 7A. Specifically, FIG. 7B shows a display 701b, the user 704, and the television remote 702. The display 701b has been changed, relative to the display 701a of FIG. 7A, to display Japanese content. This reflects that, responsive to the Japanese language speech of the user in FIG. 7A, the language settings of a computing device have changed, and both a Japanese user interface element and Japanese subtitles are being displayed.

The differences between FIG. 7A and FIG. 7B show an example of how the method described with respect to FIG. 3 may be perceived by a user, such as the user 704. In response to the Japanese-language voice command by the user 704, a computing device has modified language settings such that Japanese-language subtitles and Japanese-language user interface elements may be displayed by the display 701b.

FIG. 8 shows examples of user profiles, such as those described with respect to step 305 of FIG. 3. Specifically, FIG. 8 shows a first user profile 800a and a second user profile 800b. These user profiles may be for different users, such as two different members of the same household.

The first user profile 800a shows that a first user speaks two languages (English and Spanish), with one (English) being preferred for subtitles, and the other (Spanish) being only understood at a basic level by the first user. The first user profile 800a also shows that the first user prefers that subtitles be on for all content. The first user profile 800a further shows accessibility settings that provide that audio is to be played back at half speed, and that enlarged fonts are to be displayed (e.g., for user interface elements and subtitles).

The second user profile 800b shows that a second user speaks three languages (Korean, Chinese, and English), with one (Korean) being preferred for all content, and the other two (Chinese and English) being understood at only a basic level. The second user profile 800b also shows that the second user prefers that subtitles be enabled for content in languages that the second user does not speak (that is, languages other than Korean, Chinese, and English). The second user profile 800b further shows recording settings specifying that recording gain should be increased when recording audio data associated with the second user.

FIG. 9 shows an example of a deep neural network architecture 900. Such a deep neural network architecture may be all or portions of the machine learning software, such as may be implemented via the computing devices described above with respect to FIG. 1 and/or FIG. 2. Also or alternatively, the architecture depicted in FIG. 9 may be implemented using a plurality of computing devices (e.g., one or more of the devices 101, 105, 107, 109). Moreover, such a deep neural network architecture may be used to implement, e.g., the machine learning models implemented herein, such as those described with respect to FIG. 5. An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 910, one or more hidden layers 920, and an output layer 930. A deep neural network, as used herein, may be an artificial network that has more than one hidden layer. The example neural network architecture 900 is depicted with three hidden layers, and thus may be considered a deep neural network. The number of hidden layers employed in deep neural network 900 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process (e.g., as described with respect to step 501 and/or step 508 of FIG. 5), the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

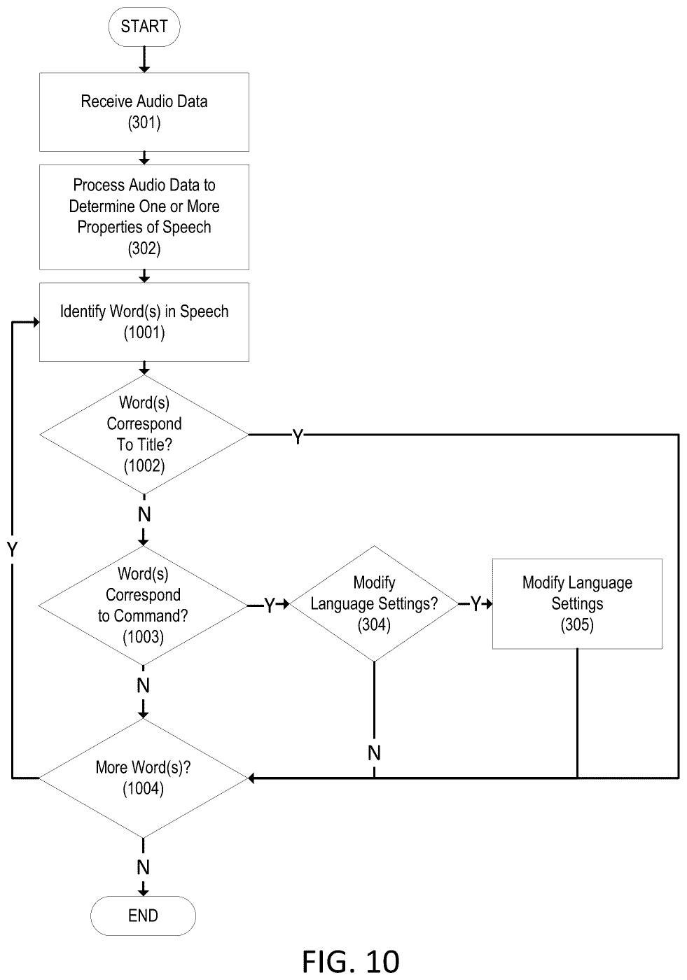

FIG. 10 is a flow chart showing an example method for modifying language settings based on the processing of audio data and based on whether words correspond to a command. Steps depicted in the flow chart shown in FIG. 10 may be performed by a computing device, such as a computing device with one or more processors and memory storing instructions that, when executed by the one or more processors, cause performance of one or more of the steps of FIG. 10. Such computing device may comprise, for example, one or more gateways (e.g., the gateway 111), television set-top boxes, personal computers, laptops, desktop computers, servers, smartphones, or the like, including any of the computing devices discussed with respect to FIG. 1 and/or FIG. 2. The steps depicted in the flow chart shown in FIG. 10 may additionally and/or alternatively be performed by one or more devices of a system, and/or as performed when stored on computer-readable media. The steps shown in FIG. 10 may be reconfigured, rearranged, and/or revised, and/or one or more other steps added.

Steps 301-302 of FIG. 10 may be the same or similar as steps 301-302 of FIG. 3.

Step 1001 through step 1004 recite a loop whereby words are evaluated and, based on determining that one or more words correspond to a command, the computing device decides whether to modify language settings. Given the wide variety of different content titles, it might not be immediately apparent which words are intended to be commands and which words are intended to correspond to content titles. As such, the loop depicted in step 1001 through step 1004 may be repeated for different permutations and/or combinations of words in the speech of the user, such that commands might be distinguished from titles, stop words, and the like. For example, the user might say “Play Play The Football Game,” with “Play the Football Game” being the title of a movie. In such a circumstance, the loop depicted in step 1002 might analyze each word individually (“Play,” “Play,” “The,” “Football,” “Game”) and words in combination (“Play Play,” “The Football,” “Football Game,” “Play The Football,” “Play The Football Game,” etc.). Based on such testing of various permutations, the computing device might ultimately correctly identify that “Play” corresponds to a command, whereas “Play The Football Game” is the title of a movie. Such a process might be particularly useful where, for instance, a user is prone to stuttering or repeating words.

In step 1001, the computing device may identify one or more words in the speech of the audio data received in step 301. The computing device may subdivide speech of the user (e.g., a full sentence spoken by a user) into discrete portions (e.g., individual words or phrases), and the identified portion in step 1001 may be one of those subdivided portions. For example, the phrase “play [MOVIE NAME]” may be divided into two portions: a first portion corresponding to “play,” and a second portion corresponding to “[MOVIE NAME].” In this example, the loop depicted from step 1001 to step 1004 might be repeated twice: once for “play,” and once for “[MOVIE NAME].”

In step 1002, the computing device may determine if the one or more words identified in step 1001 correspond to a title. If those words do correspond to a title, the flow chart proceeds to step 1004. Otherwise, the flow chart proceeds to step 1003.

In step 1003, computing device may determine if the one or more words identified in step 1001 correspond to a command. This may be effectuated by comparing the identified words to a list of words known to be associated with commands. That list of words might indicate commands in different languages, such as the word “play” in a variety of different languages. In turn, as part of step 1003, the computing device might not only determine that the words correspond to a command, but the language with which the user spoke the command in. If those words do correspond to a title, the flow chart proceeds to step 304. Otherwise, the flow chart proceeds to step 1004.

Step 304 in FIG. 10 may be the same or similar as step 304 of FIG. 3. As part of step 304, and based on determining that one or more words correspond to a command, the computing device may determine whether to modify language settings. For example, if the language settings are in English but the command was spoken in Spanish, the computing device may determine whether to switch the language settings from English to Spanish. If the computing device determines to modify the language settings, the flow chart may proceed to step 305, which may be the same or similar as step 305 of FIG. 3. Otherwise, the method may proceed to step 1004.

In step 1004, the computing device may determine whether there are more words to process. As indicated above, step 1001 through step 1004 may form a loop whereby the computing device may iteratively process different portions of user speech to determine whether one or more of those words correspond to a command. In turn, as part of step 1004, if there are additional words and/or permutations of words to process, the computing device may return to step 1001. Otherwise, the flow chart may end.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, audio data corresponding to speech of a user;
processing the audio data to determine one or more properties of the speech of the user;
comparing the one or more properties of the speech of the user to language settings of the computing device; and
modifying, based on the comparing and based on determining that the speech of the user corresponds to a command, the language settings of the computing device.

2. The method of claim 1, wherein the one or more properties of the speech of the user comprise an indication of a language spoken by the user, and wherein modifying the language settings of the computing device comprises:
modifying the language settings based on the language spoken by the user.

3. The method of claim 1, wherein processing the audio data to determine the one or more properties of the speech of the user comprises determining a speech pattern of the user, and wherein modifying the language settings of the computing device comprises:
implementing accessibility features of the computing device.

4. The method of claim 1, wherein receiving the audio data corresponding to the speech of the user comprises receiving the audio data corresponding to the speech of the user via a user device, the method further comprising:
modifying, based on the one or more properties of the speech of the user, recording settings of the user device.

5. The method of claim 1, wherein modifying the language settings of the computing device comprises:
selecting, based on the one or more properties of the speech of the user, content; and
causing display of the content.

6. The method of claim 1, wherein modifying the language settings of the computing device comprises one or more of:
modifying subtitle settings of the computing device;
causing the computing device to perform machine translation of text content; or
modifying a playback speed of content.

7. The method of claim 1, further comprising:
storing a user profile that indicates the one or more properties of the speech of the user; and
providing, to one or more second computing devices, the user profile.

8. The method of claim 1, wherein modifying the language settings of the computing device comprises:
modifying display properties of a user interface provided by the computing device.

9. The method of claim 1, wherein the audio data corresponds to speech of a plurality of different users, wherein processing the audio data to determine one or more properties of the speech of the user comprises determining a language spoken by two or more of the plurality of different users.

10. The method of claim 1, wherein the processing the audio data to determine one or more properties of the speech of the user comprises:
training, using training data, a machine learning model to identify speech properties of users, wherein the training data comprises associations between audio content corresponding to speech of a plurality of different users and properties of the speech of the plurality of different users;
providing, as input to the trained machine learning model, the audio data; and
receiving, as output from the trained machine learning model, an indication of the one or more properties of the speech of the user.

11. A method comprising:
training, using training data, a machine learning model to identify speech properties of users, wherein the training data comprises associations between audio content corresponding to speech of a plurality of different users and properties of the speech of the plurality of different users;
receiving, by a computing device, audio data corresponding to speech of a first user;
providing, as input to the trained machine learning model, the audio data;
receiving, as output from the trained machine learning model, an indication of one or more properties of the speech of the first user; and
modifying, based on the one or more properties of the speech of the first user and based on determining that the speech of the user corresponds to a command, language settings of the computing device.

12. The method of claim 11, further comprising:
after modifying the language settings of the computing device, receiving an indication that the first user further modified the language settings of the computing device; and
causing the trained machine learning model to be further trained based on the indication that the first user further modified the language settings of the computing device.

13. The method of claim 11, wherein the audio content corresponding to speech of the plurality of different users corresponds to commands spoken by the plurality of different users, and wherein the properties of the speech of the plurality of different users indicates a language of the commands spoken by the plurality of different users.

14. The method of claim 11, wherein modifying the language settings of the computing device comprises:
implementing accessibility features of the computing device.

15. A method comprising:
receiving, by a computing device, first audio data corresponding to speech by a first user;
storing, based on one or more first properties of the speech of the first user, a user profile indicating language settings for the computing device;
receiving, by the computing device, second audio data;
comparing the language settings with one or more second properties of the second audio data; and
modifying, based on the comparing, based on determining that the speech of the user corresponds to a command, and based on the one or more second properties of the second audio data, the user profile.

16. The method of claim 15, wherein comparing the language settings with the one or more second properties of the second audio data comprises:
determining whether the second audio data is associated with the first user.

17. The method of claim 15, wherein receiving the first audio data comprises receiving the first audio data via a first user device associated with the first user, and wherein receiving the second audio data comprises receiving the second audio data via a second user device associated with a second user.

18. The method of claim 15, wherein the modified user profile indicates a plurality of languages, the method further comprising:
causing display of video content corresponding to a first language of the plurality of languages; and
causing display of subtitles corresponding to a second language of the plurality of languages.

19. The method of claim 15, wherein modifying the user profile comprises:
adding, to the user profile, an indication of an accessibility feature to be implemented via the computing device.

20. The method of claim 15, further comprising:
causing a second computing device to display content based on the modified user profile.
